(19) United States
(12) Patent Application Publication
(10) Pub. No.: US 2012/0233671 A1
(43) Pub. Date: Sep. 13, 2012

(54) SYSTEM AND METHOD FOR SELECTIVE PROTECTION OF INFORMATION ELEMENTS

(76) Inventors: Leonid Beder, Carmiel (IL); Leonid Dorrendorf, Maale Adumim (IL); Pavel Berengoltz, Petah-Tikva (IL)

(21) Appl. No.: 13/510,268

(22) PCT Filed: Nov. 16, 2010
(86) PCT No.: PCT/IL10/00952

§ 371 Date: May 16, 2012

Related U.S. Application Data
(60) Provisional application No. 61/262,295, filed on Nov. 18, 2009.

(51) Int. Cl. G06F 21/00

(52) U.S. Cl. 726/4

(57) ABSTRACT

A system and method for selective protection of information items is provided a one or more information elements in an information object may be identified. Selected information elements in an information object may be encrypted. Placeholders may replace selected information elements. Presentation of information included in the information object may comprise a presentation of placeholders substituting information elements. Contingent on an authentication, placeholders may be replaced by associated information elements. Contingent on an authentication, information elements may be viewed and/or manipulated.

### BACKGROUND OF THE INVENTION

A large and increasing portion of the information handled in today's modern office environment is digital. Many organizations, institutions and establishments store, handle and manipulate most of their information in digital forms. In many cases, such information may include confidential, secret or otherwise sensitive information, which, in the wrong hands, may cause serious damage to the owner or keeper of the information and/or to those associated with the owner and/or keeper of the information.

Various techniques for protecting information exist. Methods and systems for preventing sensitive information from being copied, sent or even viewed by unauthorized individuals, organizations or other entities exist and are known in the art. For example, information may be stored in encrypted form and/or communicated over secured connections.

However, current methods and systems enable protecting information at an object or file level but not enable selectively protecting selected information items included in an information object.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIGS. 1A, 1B and 1C show exemplary screen shots according to embodiments of the invention;

FIG. 2 shows an exemplary flowchart according to embodiments of the invention;

FIG. 3 shows an exemplary computing device according to embodiments of the invention; and

FIG. 4 shows an exemplary computing device according to embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like.

Unless explicitly stated, the method embodiments described herein are not constrained to a particular order or sequence. Additionally, some of the described method embodiments or elements thereof can occur or be performed at the same point in time.

While methods and systems for protecting data, e.g., encryption of, or conditional access to information may exist, security may still be jeopardized even with such measures in place. For example, while files in an organization may be protected from unauthorized copying or sending by mail, a user may print hard copies of a document and provide such copies to a person who would otherwise be prevented from obtaining material contained in the original files. A “print screen” functionality may be another example enabling users to circumvent security measures such as described above, e.g., by producing an image of a screen displaying confidential information and saving image and/or providing it to a third, possibly hostile party. Alternatively or additionally, users may capture information using customized or reprogrammed software and/or hardware components, for example, PCI devices or device drivers may be programmed or manipulated such that a capture of information (that may not be protected, e.g., encrypted) being handled by such components is enabled.

Generally, a security breach may be related to various manipulations of information or related functionalities, e.g., output functionalities such as printing or even displaying information on a computer screen or any transfer of information between computing devices or between components in a computing device. Furthermore, information may be photographed or scanned or even videotaped, possibly at an analog level. Embodiments of the invention may enable avoiding such security risks as described herein.

According to embodiments of the invention, information items or elements may be selectively removed from, or replaced in an information object prior to enabling an access to the information object, displaying the information object, printing it or otherwise manipulating it. Selected elements, items, fields, values or other parameters in an information object may be replaced by a placeholder that may conceal the actual and/or original item or parameter. For example, a patient's record, possibly stored as a file, may contain personal information of the patient. The record may contain fields such as the patient's name, age, gender, known diseases etc. According to embodiments of the invention, selective fields and/or associated values in such record may be replaced by a placeholder prior to displaying the patient's record, printing it or otherwise presenting or providing it.

According to embodiments of the invention, the placeholders replacing actual fields, items, values or parameters may be interactive entities. For example, a placeholder may be a widget, e.g., a graphical user interface (GUI) widget as known in the art. In some embodiments, a placeholder may enable a user to provide an authentication parameter, credentials or other parameters, e.g., a password, key or personal identification number (PIN). Upon authenticating the user, application or other entity requesting access to the information protected, e.g., by the placeholder, the placeholder may be replaced by the actual information, thus presenting the otherwise protected information, e.g., enabling a visibility of the information or otherwise enabling access to the information.

In some embodiments, various access levels may be enabled, allowed and or granted, possibly based on security levels, permission levels and/or user or application associated parameters. For example, contingent on receiving a valid password, a placeholder widget may allow and/or enable a user to view a value of a field, for example, the placeholder may be replaced by the actual data, such placeholder widget may enable an administrator to modify such field. Any number of permission levels, associated actions, authentication methods may supported as known in the art without departing from the scope of the invention.

In some embodiments, protecting or concealing information may be performed at the output level. For example, while the actual information object, e.g., file or database record may be left unchanged, sensitive, confidential or other selected items in the information object may be replaced by and/or during output procedures. For example, a filter module may be installed and configured to process information obtained from a file system and remove selected items prior to a presentation on a computer screen. Alternatively or additionally, a hook in a printer software driver may be configured to replace selected items in a file, record or other information object prior to printing them.

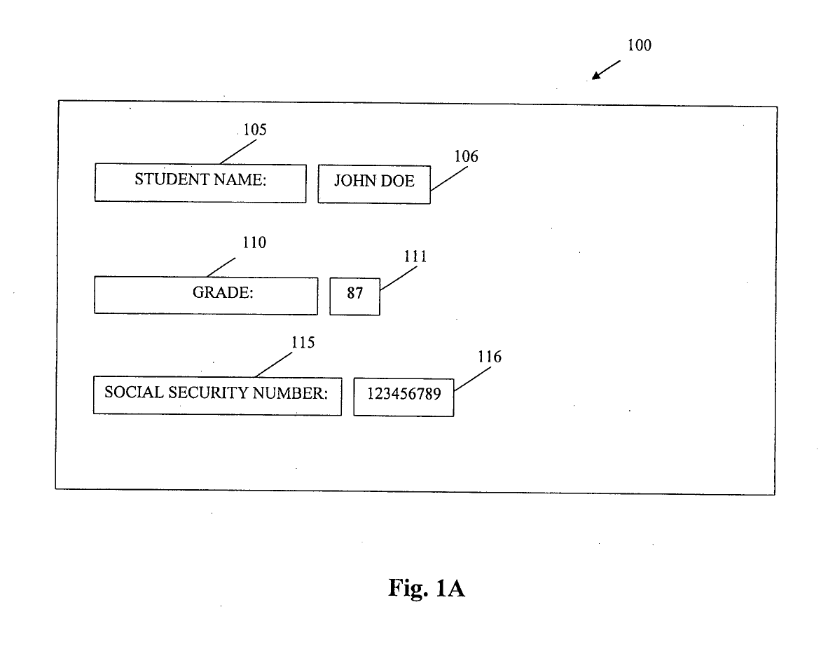

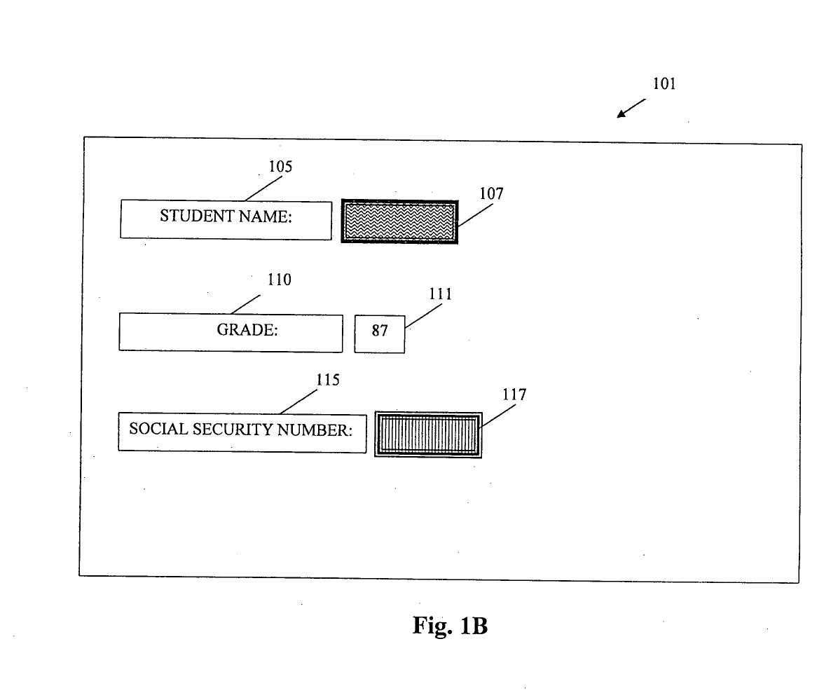

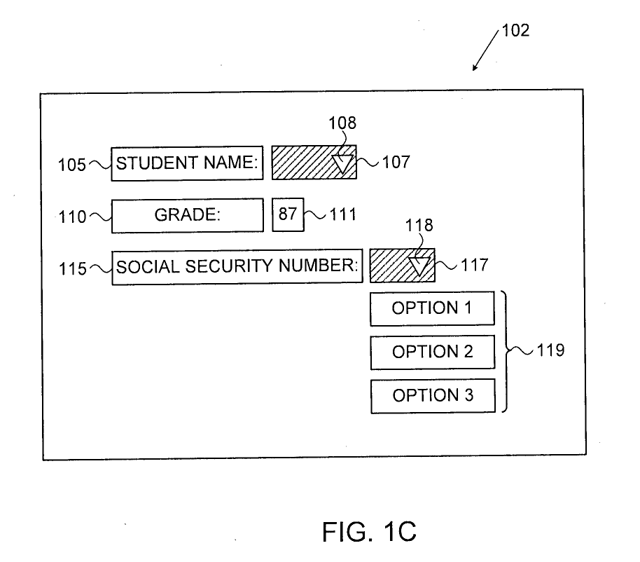

Reference is made to FIG. 1A showing an exemplary screen shot 100 according to embodiments of the invention. The exemplary screen shot shows exemplary fields 105, 110 and 115. As shown, field 105 may be a student name, field 110 may be a grade and field 115 may be a social security number field. As shown, fields 105, 110 and 115 may be associated with respective values 106, 111 and 116. For example as shown, the student name may be John Doe, the grade may be 87 and the social security may be 123456789.

Reference is made to FIG. 1B showing an exemplary screen shot 101 according to embodiments of the invention. Screen shot 101 may be related to screen shot 100. For example, fields 105, 110 and 115 shown in screen shot 101 may be similar to those shown in screen shot 100. As shown by 107 and 117, selected items may be concealed, hidden or otherwise protected. For example, student name shown as shown by 106 in FIG. 1A may be hidden as shown by 107. Likewise, social security number shown as shown by 116 in FIG. 1A may be concealed, obscured or masked as shown by 117. According to embodiments of the invention, while selected fields, items, values or other objects may be protected, e.g., hidden or concealed, other items or elements may be visible or presented. For example as shown by 111 in FIG. 1B, the value associated with the grade may be visible while other elements are hidden. Selectively hiding information elements and/or selectively presenting information elements in an information object may enable embodiments of the invention to selectively present selected information elements in an information object according to various parameters, permissions, users, applications context and the like.

Reference is made to FIG. 1C showing an exemplary screen shot 102 according to embodiments of the invention. Screen shot 102 may be related to screen shots 100 and 101. For example, fields 105, 110, 107, 111 and 117 shown in screen shot 102 may be similar to those shown in screen shot 101. As shown by 108 and 118, an object replacing an information item may include an interactive element. For example, 108 and 118 may be a pull-down menu as known in the art. As shown by 119, possibly by pressing button 118, a menu may be presented to a user. Such menu may present a number of options, e.g., option 1, 2 and 3 as shown. Options presented may be, for example, “view hidden content”, “view and modify hidden content” etc. Alternatively or additionally, options 119 may enable different users, possibly associated with different permissions or security levels to interact with content. for example, option 1 may enable a user to view some of the hidden content while option 2 may enable an administrator to view all hidden content. For example, pressing one of the options shown by 119 may cause prompting a user for a password and, contingent on verifying such password, presenting information protected as shown by 117.

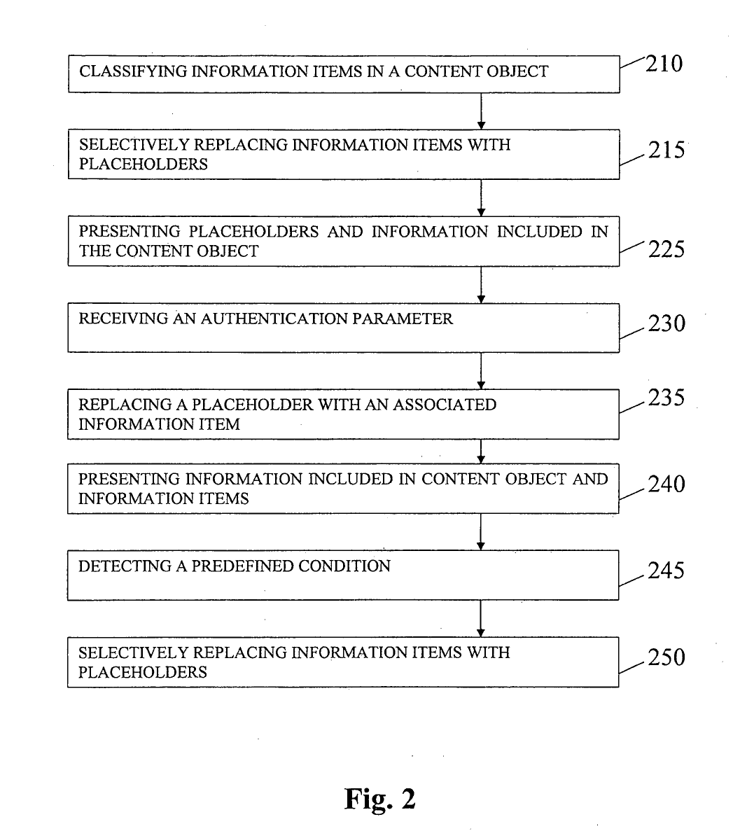

Reference is made to FIG. 2 showing an exemplary flowchart according to embodiments of the invention. As shown by 210, the flow may include classifying information items in a content object. According to embodiments of the invention, classification may be performed according to any suitable parameters, indications, rules, thresholds, criteria, settings, configuration, context or applicable aspects. For example, a filter driver, kernel module or other module may classify fields in a database record or file. For example, a file containing student information may be processed according to a predefined rule that may define sensitive elements and/or designate selected elements as confidential. For example, such rule may define that a student's name and social security number are sensitive or confidential information elements while a grade is non-confidential. Accordingly, the name and social security number fields may be classified as “restricted view” items. An information item or element may be classified according to a number of levels, for example, “unrestricted”, “sensitive” and “highly sensitive”.

Inspection of a content object, e.g., a file, and a classification of elements in an inspected object may be performed by any suitable entity. For example, a filter driver associated with a storage device may perform classification of items in an information object. For example, such classification may be performed when the information object is stored in the storage device and/or retrieved from the storage device. For example, a filter driver may be associated with a file system on a hard drive installed in a computing device. Such filter driver may process information being retrieved from the file system, e.g., a file, and may classify, as described herein, elements, fields, parameters or any applicable items in a file being retrieved from the file system. Similarly, such classification may be performed upon storing a file or any other information object in the file system or in any applicable storage system. Another exemplary component that may be used by embodiments of the invention may be a graphical device interface (GDI) driver that may, as known in the art, perform a representation of graphical objects and a transmission of graphical information to an output device, e.g., a monitor or printer. According to embodiments of the invention, a GDI driver may be programmed or otherwise modified or adapted to perform a classification of information as described herein. For example, information destined to a monitor or printer may be processed by a GDI driver and a classification of information may be performed before the information is provided or delivered to an output device.

Elements classification may be relevant to a granting of permission to view or interact with a protected elements. For example, an item classified as “unrestricted” may be freely presented, e.g., as shown by 111 in FIG. 1, an item classified as “sensitive” may be protected but presented to staff level users and an item or element classified as “highly sensitive” may only be presented to an administrator. Classification of elements may be performed according to various methods. For example, if an order by which information elements are arranged in a record or file is known, then their respective classification may be according to their respective position or order in the file, record or relevant information object. Alternatively or additionally, elements may be identified by word spotting or other means. For example, if a student's name is regarded as “sensitive” information then a field containing “student name” may be searched in a record and the field and/or it's associated value may be classified accordingly. Any applicable information related to an information object being processed as described herein in order to classify elements in the object may be utilized. For example, a structure of a file, a layout of information in an object or any other attributes or relevant parameters may all be used in order to locate, classify and/or manipulate elements in an information object.

Classification information may be stored as metadata. For example, metadata related to a classification as described herein may be stored in the information object itself, e.g., a record of a student in a database of an academic institution. Alternatively, classification information may be stored separately, e.g., in an external or separate file. Association of the file or object containing the classification information and the relevant information object, e.g., the student record, may be recorded and maid available to relevant entities, e.g., a display driver, printer driver etc.

As shown by 215, the flow may include selectively replacing information items with placeholders. According to embodiments of the invention, replacement of information elements may be performed according to any suitable parameters, indications, rules, thresholds, criteria, settings, configuration, context or applicable aspects. For example, possibly based on classification information described herein, a display driver may replace selected fields, items or elements by placeholders prior to presenting information in an information object. For example, prior to presenting information pertaining to a student as shown in FIG. 1, selected elements, e.g., the student's name may be replaced by a placeholder. Such replacement may be performed by a display system in order, to protect information displayed on a computer screen. Replacement of information elements may be performed by a printer driver so that selected fields or items are not printed. Replacement as described herein may be performed by a file system related module, accordingly, copying an information object, e.g., a student's record may comprise replacing sensitive information. Accordingly, a copy of a file, for example, to a removable or other storage device may include removal or replacement of sensitive sections in the file. Accordingly, the copied or duplicated file may not contain sections or items classified as sensitive or otherwise designated as elements that may not be presented without proper authentication. Selective replacement of information elements as described herein may be performed in various situations or conditions and may, accordingly, be performed regardless of an operation or manipulation of the relevant information object.

It will be recognized that any element, item, structure, parameter or any applicable data or content in an information object may be replaced as described herein. For example, a byte (eight bits), a word (two bytes), a text string, a table, a list or field in a list, a value or parameter may be selected for replacement according to embodiments of the invention. Likewise, any applicable element, item, parameter or structure may be used to replace or substitute and element as described herein. For example, an information element, e.g., a value in a table entry, may be removed from a file and possibly stored in another, second file. A special code or parameter may replace such removed information element in the file. Such special code or parameter may be used in order to locate, e.g., in the second file, the actual or original information element, e.g., the value in a table entry. Alternatively or additionally, an information element may be replaced by an executable code section, a pointer, a dummy value or any applicable element. In some embodiments, an information element may be replaced by an encrypted version of itself. For example, an element may be encrypted and an encrypted version of the element may replace the original element. Such replacement may enable embodiments of the invention to only enable an authorized entity to view and/or manipulate an element thus manipulated and/or replaced.

As shown by 225, the flow may include presenting placeholders and information included in the content object. For example, as shown by FIG. 1B, information such as the grade given to a student may be presented and placeholders substituting other information elements may be presented. As shown by FIGS. 1B and 1C, hidden or otherwise protected information may be indicated by placeholders. As shown by 107 and 117 in FIG. 1B, different placeholders or placeholders attributes, e.g., color or shape, may indicate different aspects of hidden information. For example, placeholder 107 may hide or substitute an element that may be classified as “sensitive” while placeholder 117 may hide or replace an item classified as “highly sensitive”, accordingly, the color or other graphic attributes of placeholders 107 and 117 (or a graphical representation of such placeholders) may be different as shown.

As shown by 230, the flow may include receiving an authentication parameter. For example, as shown by 119 in FIG. 1C, a user may be provided with an option to enter a password. Any other method of authenticating may be implemented. For example, a smart card, an electronic token, or an authentication server may be used. For example, a placeholder may be implemented by a widget as known in the art. Such widget may include code to receive a password or other parameter from a user or application and may further interact with a server or perform any required operation in order to authenticate the user.

As shown by 235, the flow may include replacing a placeholder with an associated information item. For example, contingent on receiving a password from a user, placeholder 117 shown in FIG. 2 may be replaced with the social security number as shown by 116 in FIG. 1. In some embodiments, placeholders may be selectively replaced by their associated information items. For example, while placeholder 117 may be replaced by the relevant information, namely, the social security number, other elements may still be protected or hidden, e.g., placeholder 107 may still hide the student's name. In other embodiments or configurations, contingent on authentication as described, a number of or all placeholders associated with an information object may be replaced by their respective associated information elements. For example, upon receiving a password from a user, both placeholders 107 and 117 may be replaced by their respective, previously hidden values. As shown by 240, possibly subsequent to replacing placeholders with their respective values, information elements or items, the flow may include presenting information included in content object and information items. For example, as shown in FIG. 1A, rather than displaying the placeholders and other, non-hidden fields or items, the actual values, fields or elements may be presented.

As shown by 245, the flow may include detecting a predefined condition. Exemplary events or conditions may be an explicit user request, a timeout, an activation of a predefined application, e.g., a screen saver, or detecting a predefined state or operational status of the relevant computing device, e.g., a workstation being locked or entering a standby, hibernation or shutdown mode, a change of the active user, e.g., logoff or switching to another user etc. As shown by 250, possibly upon detecting a condition or event as described herein, the flow may include selectively replacing information items with placeholders. According to embodiments of the invention, sensitive information presented or unlocked as described herein may be automatically and/or selectively locked, hidden or replaced by a placeholder in response to various events, conditions or parameters. Any applicable conditions or events may trigger a concealment or hiding of information items by replacing such items with placeholders as described herein.

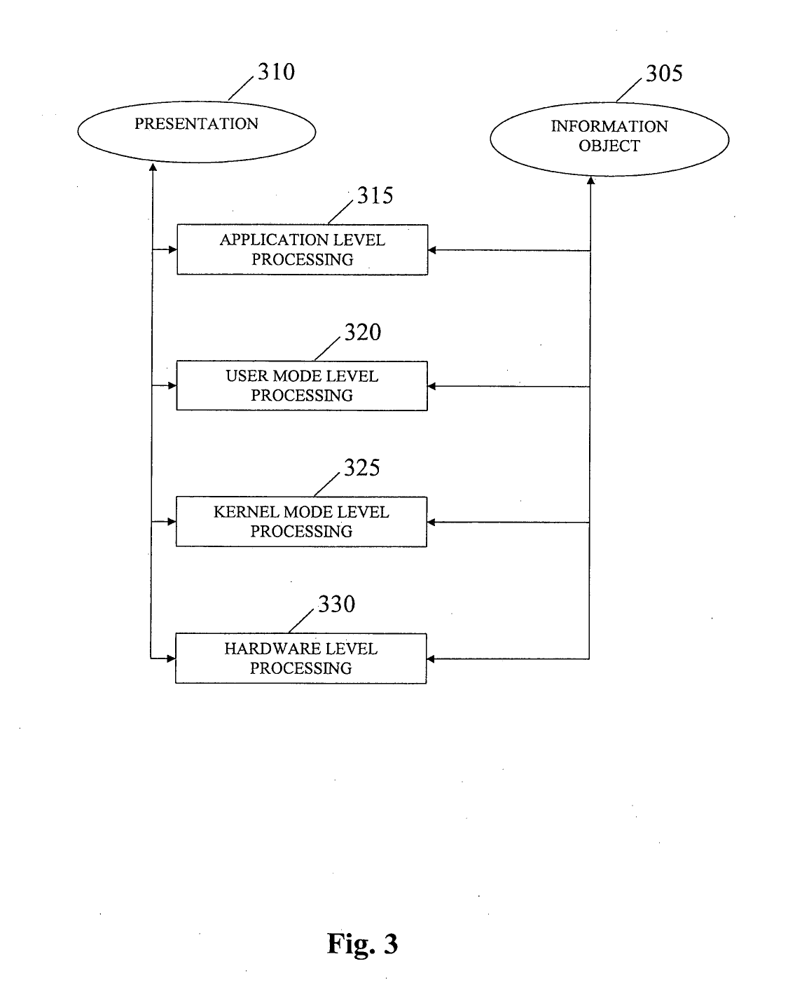

Reference is made to FIG. 3 showing exemplary relevant processing levels according to embodiments of the invention. FIG. 3 shows an information object 305, a presentation 310, a hardware level 330, a kernel mode level 325, a user mode level 320 and an application level 315. As shown, a presentation 310 of an information object 305 may be subsequent to processing by one or more levels. As shown, processing levels may be a hardware level 330, a kernel mode level 325, a user mode level 320 and/or an application level 315. A presentation 310 may be a rendering of information on a display screen, a printing of information by a printer, playing multimedia content by a speaker and/or any other applicable presentation or providing of content, e.g., contained by information object 305. Information object 305 may be a file, a record or any other applicable content or information object. As shown by the arrows connecting information object 305 to levels 315, 320, 325 and 330, an information object may be processed by any level shown, or by a combination of levels, e.g., by hardware level 330 and by application level 315. Such processing may be performed prior to the information object being displayed, printed, provided to an output device, communicated from a first computing device to a second computing device, e.g., over a network, copied or transferred from a first storage device to a second storage device or otherwise delivered or communicated. Such processing may include classifying information elements and/or selectively replacing information elements in the information object with placeholders and/or manipulating related metadata or other data as described herein.

According to embodiments of the invention, an exemplary hardware level processing as shown by 330 may include processing by a specialized video adapter device configured decrypt encrypted information elements. For example, embodiments of the invention may encrypt an information element and such encrypted element may be decrypted by a specialized video adapter device. Accordingly, sensitive information may only be accessible, viewed or provided in cooperation with a specialized video adapter device. For example, a specialized video adapter device may be configured to replace placeholders or encrypted information elements by their respective, decrypted data, parameter, value or other information. Such decryption or replacement may be performed according to any suitable parameters, indications, rules, thresholds, criteria, settings, configuration, context or applicable aspects that may be part of a configuration of the decryption device. For example, a specialized video adapter card with decryption functionalities or capabilities may be used. For example, a specialized video adapter card, possibly including built-in support for data encryption and/or replacement may be used.

Another relevant hardware and/or firmware level implementation may be included in a printing device or system. For example, a printer may incorporate logic and hardware configured to detect sensitive data according to predefined rules or criteria. For example, according to a location of an item in a file to be printed. For example, a printer may be configured to print black boxes instead of actual values when or if a predefined condition is met. For example, a field in a predefined location or offset in a file may be replaced by a black box or other graphic object. Such replacement may be performed for files containing a predefined string in their name and/or content. For example, specific strings may be searched by logic incorporated in a printer in files known to contain text. Metadata suffixing, prefixing or otherwise associated with a file, content or information in a print job may be used by a printer in order to detect various elements and/or replace various elements by place holders, black boxes or any suitable object or content as described herein. Such metadata may be used by any level of processing described herein. For example, any one of levels 315, 320, 325 and/or 330 may examine metadata associated with information in order to perform hiding, replacing or otherwise manipulating sensitive information as described herein. For example, metadata associated with information to be printed, displayed, duplicated, copied or communicated may include pointers to sensitive elements, e.g., an offset of a value or string in a file. Any other information related to detecting, replacing or otherwise manipulating information as described herein may be included in metadata associated with information as described herein.

Kernel mode level 325 processing may include text output routines in the kernel. User mode level 320 processing may include text output routines executed in user-mode, e.g., graphics subsystems, programming libraries and/or program or routines operating in a system shell. Application level 315 processing may be or include an application displaying data contained in information object 305 and/or an application programming interface (API) or a GUI widget that may perform data recognition, removal and/or replacement.

Kernel mode level 325 processing may include OS components and/or drivers. For example, processing of data and a replacement of elements in data may be performed by OS components when passing data objects between applications and/or hardware components. Hardware level 330 processing may include hardware devices, such as buses, PCI extension cards, memory and disk devices and/or input output (I/O) devices. Such devices may be configured to perform data concealment or replacement during their normal handling of data. For example, when receiving, passing, communicating or storing data objects. Information or data manipulated as described herein may be in any applicable form, format or representation. For example, data processed as described herein may be binary buffers, strings, function arguments, structured objects, database objects etc. Any applicable processing related to security as described herein may be performed by any one or more of the levels shown in FIG. 3. For example, inspection, classification, removal and replacement by placeholders or encryption may all be performed by the processing levels shown in FIG. 3.

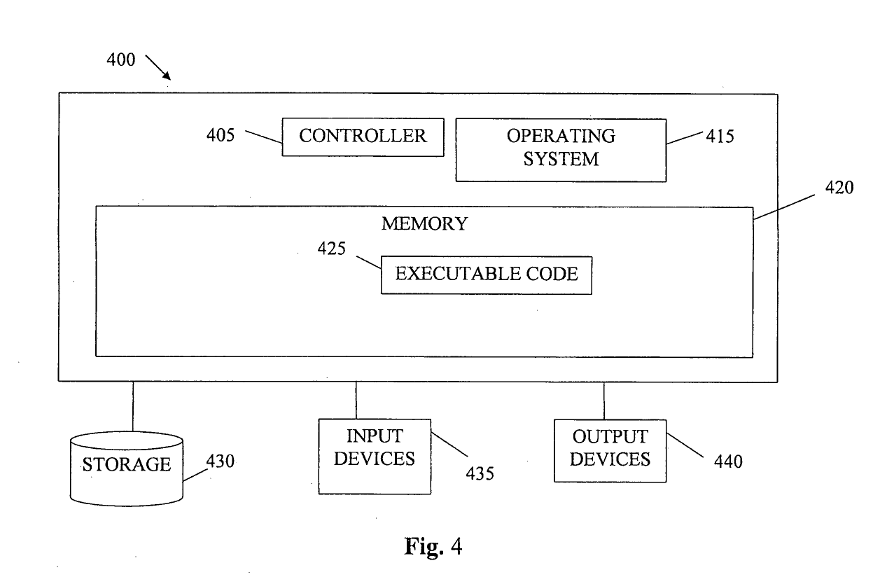

Reference is made to FIG. 4, showing high level block diagram of an exemplary computing device according to embodiments of the present invention. Computing device 400 may include a controller 405 that may be, for example, a central processing unit processor (CPU), a chip or any suitable computing or computational device, an operating system 415, a memory 420, a storage 430, an input device 435 and an output device 440.

Operating system may be or may include any code segment designed and/or configured to perform tasks involving coordination, scheduling, arbitration, supervising, controlling or otherwise managing operation of computing device 400, for example, scheduling execution of programs. Operating system 415 may be a commercial operating system. Memory 420 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 420 may be or may include a plurality of, possibly different memory units.

Executable code 425 may be any executable code, e.g., an application, a program, a process, task or script. For example, executable code 425 may be a program configured to process a file or other information object and to perform data recognition, removal and/or replacement, e.g., substitute or replace selected elements in a file with null characters, widgets or reference to other objects.

Executable code 425 may be executed by controller 405 possibly under control of operating system 415. Storage 430 may be or may include, for example, a hard disk drive, a floppy disk drive, a Compact Disk (CD) drive, a CD-Recordable (CD-R) drive, a universal serial bus (USB) device or other suitable removable and/or fixed storage unit.

Input devices 435 may be or may include a mouse, a keyboard, a touch screen or pad or any suitable input device. It will be recognized that any suitable number of input devices may be operatively connected to computing device 400 as shown by block 435. Output devices 440 may include one or more displays, speakers and/or any other suitable output devices. It will be recognized that any suitable number of output devices may be operatively connected to computing device 400 as shown by block 440. Any applicable input/output (I/O) devices may be connected to computing device 400 as shown by blocks 435 and 440. For example, a network interface card (NIC), a printer or facsimile machine, a universal serial bus (USB) device or external hard drive may be included in input devices 435 and/or output devices 440.

Embodiments of the invention may include an article such as a computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein. For example, a storage medium such as memory 420, computer-executable instructions such as executable code 425 and a controller such as controller 405. Some embodiments may be provided in a computer program product that may include a machine-readable medium, stored thereon instructions, which may be used to program a computer, or other programmable devices, to perform methods as disclosed above.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method for selectively protecting information elements in a content object, the method comprising:
selectively replacing at least a first information element included in said content object by a placeholder;
presenting at least a second information element included in said content object and said placeholder;
contingent on receiving an authentication parameter, replacing said placeholder by said at least first information element; and
presenting said at least first information element and said at least second information element.

2. The method of claim 1, comprising encrypting said first information element.

3. The method of claim 1, comprising associating said at least first information element with a plurality of access permissions.

4. The method of claim 1, comprising:
disabling a manipulation of said first information element; and
contingent on receiving an authentication parameter, enabling a manipulation of said at least first information element.

5. The method of claim 2, comprising encrypting said at least first information element for decryption by a specialized video adapter device.

6. The method of claim 1, comprising:
selectively encrypting a first plurality of information elements included in said content object to produce a first plurality of encrypted information elements;
replacing said first plurality of information elements by a respective plurality of placeholders;
presenting a second plurality of information elements included in said content object and said plurality of placeholders to a user; and
contingent on authenticating said user, selectively decrypting at least one information element selected from said first plurality of encrypted information elements and presenting said one decrypted information element and said second plurality of information elements to said user.

7. The method of claim 6, comprising selectively encrypting said first plurality of information elements according to an association with a respective plurality of predefined fields in said content object.

8. The method of claim 1, comprising selectively replacing said plurality of information elements with a respective plurality of placeholders according to an association of said plurality of information elements with a respective plurality of predefined fields in said content object.

9. The method of claim 1, wherein said placeholder is configured to interact with a user to receive an authentication parameter and to cause a replacement of said placeholder by an associated information element.

10. The method of claim 1, comprising automatically replacing an information element by a placeholder upon detecting one of: a timer expiration, an activation of a predefined application, a predefined operational state of a relevant computing device, a logoff of a user and a logon of a user.

11. An article comprising a computer-readable storage medium, having stored thereon instructions, that when executed on a computer, cause the computer to:
selectively replace at least a first information element included in a content object by a placeholder;
present at least a second information element included in said content object and said placeholder;
contingent on receiving an authentication parameter, replace said placeholder by said at least first information element; and
present said at least first information element and said at least second information element.

12. The article of claim 11, wherein the instructions when executed further result in encrypting said first information element.

13. The article of claim 11, wherein the instructions when executed further result in associating said at least first information element with a plurality of access permissions.

14. The article of claim 11, wherein the instructions when executed further result in:
disabling a manipulation of said first information element; and
contingent on receiving an authentication parameter, enabling a manipulation of said at least first information element.

15. The article of claim 12, wherein the instructions when executed further result in encrypting said at least first information element for decryption by a specialized video adapter device.

16. The article of claim 11, wherein the instructions when executed further result in:
selectively encrypting a first plurality of information elements included in said content object to produce a first plurality of encrypted information elements;
replacing said first plurality of information elements by a respective plurality of placeholders;
presenting a second plurality of information elements included in said content object and said plurality of placeholders to a user; and
contingent on authenticating said user, selectively decrypting at least one information element selected from said first plurality of encrypted information elements and presenting said one decrypted information element and said second plurality of information elements to said user.

17. The article of claim 16, wherein the instructions when executed further result in selectively encrypting said first plurality of information elements according to an association with a respective plurality of predefined fields in said content object.

18. The article of claim 11, wherein the instructions when executed further result in selectively replacing said plurality of information elements with a respective plurality of placeholders according to an association of said plurality of information elements with a respective plurality of predefined fields in said content object.

19. The article of claim 11, wherein said placeholder is configured to interact with a user to receive an authentication parameter and to cause a replacement of said placeholder by an associated information element.

20. The article of claim 11, wherein the instructions when executed further result in automatically replacing an information element by a placeholder upon detecting one of: a timer expiration, an activation of a predefined application, a predefined operational state of said article, a logoff of a user and a logon of a user.
